(19) United States
(12) Patent Application Publication
(10) Pub. No.: US 2017/0371460 A1
(43) Pub. Date: Dec. 28, 2017

(54) TOUCH SIGNAL SCANNING METHOD

(71) Applicants: SHENZHEN CHINA STAR OPTOELECTRONICS TECHNOLOGY CO., LTD., Shenzhen, Guangdong (CN); WUHAN CHINA STAR OPTOELECTRONICS TECHNOLOGY CO., LTD., Wuhan (CN)

(72) Inventors: Jianxing XIE, Shenzhen (CN); Chun-Hung HUANG, Shenzhen (CN)

(73) Assignees: SHENZHEN CHINA STAR OPTOELECTRONICS TECHNOLOGY CO., LTD., Shenzhen, Guangdong (CN); WUHAN CHINA STAR OPTOELECTRONICS TECHNOLOGY CO., LTD., Wuhan (CN)

(21) Appl. No.: 14/648,930

(22) PCT Filed: Apr. 2, 2015
(86) PCT No.: PCT/CN2015/075810

§ 371 Date: Jun. 2, 2015

(30) Foreign Application Priority Data
Mar. 18, 2015 (CN) 201510119781.0

(51) Int. Cl. G06F 3/041

(52) U.S. Cl. CPC G06F 3/0412; G06F 2203/04104

(57) ABSTRACT

A touch signal scanning method is disclosed, and the touch signal scanning method has steps of: transmitting a first touch driving signal to touch driving lines; detecting a first touch sensing signal of touch sensing lines; determining at least one to-be-scanned touch sensing line according to the first touch sensing signal of the touch sensing lines and a default rule; transmitting a second touch driving signal to the to-be-scanned touch sensing line; receiving a second touch sensing signal through the touch driving lines; and determining locations of touch operations according to the second touch sensing signal.

### FIELD OF THE INVENTION

The present invention relates to a technical field of displays, and more particularly to a touch display panel and a touch display device.

### BACKGROUND OF THE INVENTION

Along with the popularity of intelligent electronic products, capacitive touch display devices are now widely used in various electronic products, for example, intelligent mobile phones or tablets. Existing capacitive touch display devices includes G-G (glass-glass, transducer glass-tempered glass), GF (glass-film), OFF (glass-film-film) and OGS (one glass solution) plug-in architectures etc., and On-cell (touch transducers disposed on a display panel) and In-cell (touch transducers embedded on a display panel) embedded architecture, etc.

However, by improving the resolution of electronic products, the time for display scanning must be longer, and the time for corresponding touch scanning will be decreased, so as to affect a touch result of a touch display device.

Therefore, it is necessary to provide a touch display panel and a touch display device to solve the above described problems.

### SUMMARY OF THE INVENTION

An object of the present invention is to provide a touch signal scanning method which has a shorter touch scanning time and does not affect the touch result of a touch display device, so as to solve a technical problem of an existing touch signal scanning method which has too short a touch scanning time, so as to affect the touch result of the touch display result.

To solve the problems described above, the technical solution of the present invention is as follows.

A touch signal scanning method is provided in an embodiment of the present invention, applied to a corresponding touch display device, wherein the touch display device comprises:

at least one touch chip transmitting touch driving signals and receiving touch sensing signals;

a plurality of touch driving lines connected to the touch chip; and

a plurality of touch sensing lines connected to the touch chip; wherein the touch chip scanning method comprises steps of:

transmitting a first touch driving signal to all of the touch driving lines by the touch chip;

detecting a first touch sensing signal of all of the touch sensing lines by the touch chip, wherein the touch sensing lines produce the first touch sensing signals according to the first touch driving signal and touch operations;

determining at least one to-be-scanned touch sensing line according to the first touch sensing signal of all of the touch sensing lines and a default rule by the touch chip;

transmitting a second touch driving signal to the to-be-scanned touch sensing line by the touch chip;

receiving a second touch sensing signal through the touch driving lines by the touch chip;

producing the second touch sensing signal according to the second touch driving signal and touch operations by the touch sensing lines; and

determining locations of the touch operations according to the second touch sensing signal by the touch chip;

wherein the touch driving lines are perpendicular to the touch sensing lines.

In the touch signal scanning method of the present invention, if the touch display device is a single point touch display device, the step of determining the at least one to-be-scanned touch sensing line according to the first touch sensing signal of all of the touch sensing lines and the default rule comprises:

determining if a touch sensing line with a maximum signal volume is the to-be-scanned touch sensing line according to the first touch sensing signal of all of the touch sensing lines.

In the touch signal scanning method of the present invention, the step of determining locations of the touch operations according to the second touch sensing signal by the touch chip comprises:

determining locations of the touch operations according to the touch driving lines and the to-be-scanned touch sensing line corresponding to the second touch sensing signal by the touch chip.

In the touch signal scanning method of the present invention, the touch display device is a single point touch display device, and the step of determining at least one to-be-scanned touch sensing line according to the first touch sensing signal of all of the touch sensing lines and the default rule comprises:

determining if a touch sensing line with a maximum signal volume and n touch sensing lines adjacent thereto are the to-be-scanned touch sensing line according to the first touch sensing signal of all of the touch sensing lines, wherein n is a positive integer.

In the touch signal scanning method of the present invention, n is 1.

In the touch signal scanning method of the present invention, the step of transmitting the second touch signal to the to-be-scanned touch sensing line by the touch chip comprises:

progressively transmitting the second touch driving signal to the to-be-scanned touch sensing line by the touch chip.

In the touch signal scanning method of the present invention, the step of determining locations of the touch operations according to the second touch sensing signal by the touch chip comprises:

determining locations of touch operations according to the touch driving line corresponding to the second touch sensing signal and the touch sensing line corresponding to the second touch driving signal by the touch chip.

In the touch signal scanning method of the present invention, the touch display device is a multiple point touch display device, and the step of determining at least one touch to-be-scanned sensing line according to the first touch sensing signal of all of the touch sensing lines and the default rule comprises:

determining if a touch sensing line which has a signal volume greater than a preset value is the to-be-scanned touch sensing line according to the first touch sensing signal of all of the touch sensing lines.

In the touch signal scanning method of the present invention, the step of transmitting the second touch signal to the to-be-scanned touch sensing line by the touch chip comprises:

progressively transmitting the second touch driving signal to the to-be-scanned touch sensing line by the touch chip.

In the touch signal scanning method of the present invention, the step of determining locations of the touch operations according to the second touch sensing signal by the touch chip comprises:

determining locations of touch operations according to the touch driving line corresponding to the second touch sensing signal and the touch sensing line corresponding to the second touch driving signal by the touch chip.

A touch signal scanning method is provided in an embodiment of the present invention, applied to a corresponding touch display device, wherein the touch display device comprises:

at least one touch chip transmitting touch driving signals and receiving touch sensing signals;

a plurality of touch driving lines connected to the touch chip; and

a plurality of touch sensing lines connected to the touch chip; wherein the touch chip scanning method comprises steps of:

transmitting a first touch driving signal to all of the touch driving lines by the touch chip;

detecting a first touch sensing signal of all of the touch sensing lines by the touch chip, wherein the touch sensing lines produce the first touch sensing signals according to the first touch driving signal and touch operations;

determining at least one to-be-scanned touch sensing line according to the first touch sensing signal of all of the touch sensing lines and a default rule by the touch chip;

transmitting a second touch driving signal to the to-be-scanned touch sensing line by the touch chip;

receiving a second touch sensing signal through the touch driving lines by the touch chip;

producing the second touch sensing signal according to the second touch driving signal and touch operations by the touch sensing lines; and

determining locations of the touch operations according to the second touch sensing signal by the touch chip.

In the touch signal scanning method of the present invention, the touch display device is a single point touch display device, and the step of determining at least one to-be-scanned touch sensing line according to the first touch sensing signal of all of the touch sensing lines and the default rule comprises:

determining if a touch sensing line with a maximum signal volume is the to-be-scanned touch sensing line according to the first touch sensing signal of all of the touch sensing lines.

In the touch signal scanning method of the present invention, the step of determining locations of the touch operations according to the second touch sensing signal by the touch chip comprises:

determining locations of the touch operations according to the touch driving lines and the to-be-scanned touch sensing line corresponding to the second touch sensing signal by the touch chip.

In the touch signal scanning method of the present invention, the touch display device is a single point touch display device, and the step of determining at least one to-be-scanned touch sensing line according to the first touch sensing signal of all of the touch sensing lines and the default rule comprises:

determining if a touch sensing line with a maximum signal volume and n touch sensing lines adjacent thereto are the to-be-scanned touch sensing line according to the first touch sensing signal of all of the touch sensing lines, wherein n is a positive integer.

In the touch signal scanning method of the present invention, n is 1.

In the touch signal scanning method of the present invention, the step of transmitting the second touch signal to the to-be-scanned touch sensing line by the touch chip comprises:

progressively transmitting the second touch driving signal to the to-be-scanned touch sensing line by the touch chip.

In the touch signal scanning method of the present invention, the step of determining locations of the touch operations according to the second touch sensing signal by the touch chip comprises:

determining locations of touch operations according to the touch driving line corresponding to the second touch sensing signal and the touch sensing line corresponding to the second touch driving signal by the touch chip.

In the touch signal scanning method of the present invention, the touch display device is a multiple point touch display device, and the step of determining at least one to-be-scanned touch sensing line according to the first touch sensing signal of all of the touch sensing lines and the default rule comprises:

determining if a touch sensing line which has a signal volume greater than a preset value is the to-be-scanned touch sensing line according to the first touch sensing signal of all of the touch sensing lines.

In the touch signal scanning method of the present invention, the step of transmitting the second touch signal to the to-be-scanned touch sensing line by the touch chip comprises:

progressively transmitting the second touch driving signal to the to-be-scanned touch sensing line by the touch chip.

In the touch signal scanning method of the present invention, the step of determining locations of the touch operations according to the second touch sensing signal by the touch chip comprises:

determining locations of touch operations according to the touch driving line corresponding to the second touch sensing signal and the touch sensing line corresponding to the second touch driving signal by the touch chip.

A touch signal scanning method of the present invention shortens touch scanning time through twice scanning operations and does not affect the touch result of a touch display device, so as to solve a technical problem of an existing touch signal scanning method which has too a short touch scanning time, so as to affect the touch result of the touch display result.

To allow the above description of the present invention to be more clear and comprehensive, there are preferred embodiments with the accompanying figures described in detail below.

### DESCRIPTION OF THE DRAWINGS

FIG. 1 is a structural diagram of a touch display device applied to a touch signal scanning method of the present invention;

FIG. 2 is a flowchart of the touch signal scanning method according to the first preferred embodiment of the present invention;

FIG. 3 is a flowchart of the touch signal scanning method according to the second preferred embodiment of the present invention;

FIG. 4A is a flowchart of the touch signal scanning method according to the third preferred embodiment of the present invention;

FIG. 4B is a diagram of touch signals of the touch signal scanning method according to the third preferred embodiment of the present invention; and

FIG. 5 is a flowchart of the touch signal scanning method according to the fourth preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

In the drawings, units with similar structures are represented with the same label.

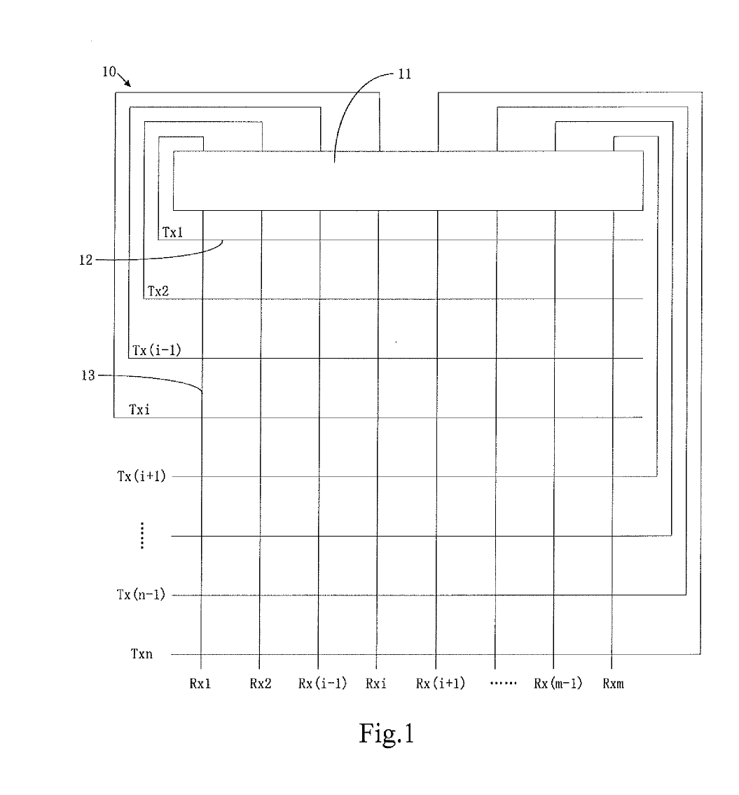

Refer to FIG. 1, which is a structural diagram of a touch display device applied to a touch signal scanning method of the present invention. The touch display device 10 includes at least one touch chip 11, a plurality of touch driving lines 12, and a plurality of touch sensing lines 13, The touch chip 11 is used to transmit touch driving signals and receive touch sensing signals; the touch chip 11 is connected to the touch driving lines 12 and the touch sensing lines 13 respectively.

When the touch display device 10 is used, the touch chip 11 progressively transmits touch driving signals to the touch driving lines 12, and then the touch chip 11 receives touch sensing signals of the touch sensing lines 13. Finally, the touch chip obtains the abscissa of the touch operation on the touch display panel according to the touch sensing signal, namely, the coordinates of touch sensing lines 13 (Rx1 to Rxm); and the touch chip 11 obtains the ordinate of the touch operation on the touch display panel according to the return time of the touch sensing signals, namely, the coordinates of touch driving lines 12 (Tx1 to Txn). The above operations of the touch chip needs to execute progressive scanning for all of the touch driving lines 12 of the whole touch display panel. When a touch display panel has a higher display resolution, the touch scanning of the touch chip 11 spends much time. If the touch scanning time of the touch chip 11 is continually reduced, the touch result of the touch display device 10 might be affected.

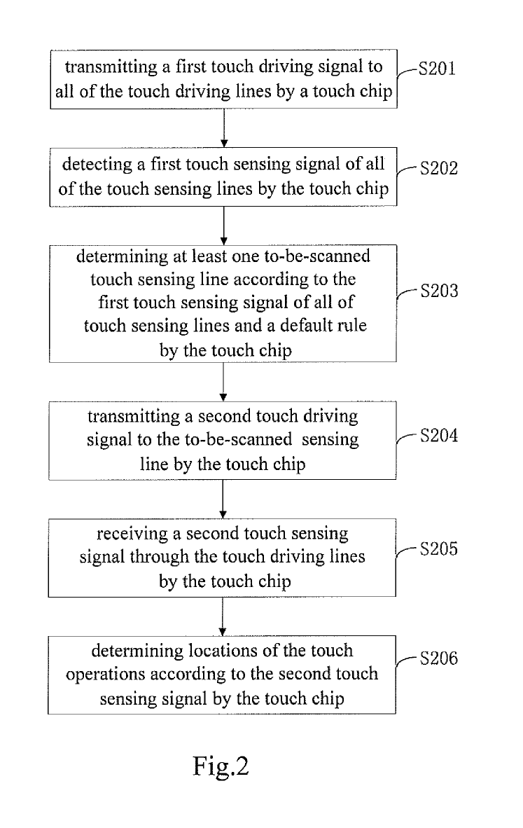

The touch signal scanning method of the present invention is applied for the touch display device 10 of FIG. 1, which can reduce the touch scanning time of the touch chip 11 without affecting the touch result of the touch display device. Refer to FIG. 2, which is a flowchart of the touch signal scanning method according to the first preferred embodiment of the present invention. The touch signal scanning method of the present invention comprises:

In a step S201, the touch chip transmits a first touch driving signal to all of the touch driving lines;

In a step S202, the touch chip detects a first touch sensing signal of all of the touch sensing lines;

In a step S203, the touch chip determines at least one to-be-scanned touch sensing line according to the first touch sensing signal of ail of the touch sensing lines and a default rule;

In a step S204, the touch chip transmits a second touch driving signal to the to-be-scanned touch sensing line;

In a step S205, the touch chip receives a second touch sensing signal through the touch driving lines; and

In a step S206, the touch chip determines locations of the touch operations according to the second touch sensing signal;

The touch signal scanning method of the preferred embodiment ends at the step S206.

The touch signal scanning method of the present preferred embodiment is described in detailed below.

At the step S201, the touch chip transmits the first touch driving signal to all of the touch driving lines; then, go to the step S202.

At the step S202, the touch sensing lines (Rx1 to Rxm) produce the first touch sensing signal according to the first touch driving signal of the touch driving line and touch operations of the touch display panel; then, the touch chip detects a first touch sensing signal of all of the touch sensing lines; then, go to the step S203.

At the step S203, the touch chip determines at least one to-be-scanned touch sensing line according to the first touch sensing signal of all of the touch sensing lines and a default rule; the default rule is based on user requirements and requirements of the touch display device; then, go to the step S204.

At the step S204, the touch chip transmits a second touch driving signal to the to-be-scanned touch sensing line. The touch chip executes the second time scanning for the to-be-scanned touch sensing line. From the step S201 to step S203, one overall scanning and the default rule reduces the second time scanning area, so as to consume less time at the second scanning; then, go to the step S205.

At the step S205, the touch sensing lines produces the second touch sensing signal according to the second touch driving signal and touch operations of the touch display panel; then, the touch chip detects the second touch sensing signal of the touch driving line; then, go to the step S206.

At the step S206, the touch chip obtains the location of the touch operation which the second touch sensing drives.

As a result, the touch signal scanning process of the touch signal scanning method of the present preferred embodiment is completed.

The touch signal scanning method of the present invention shortens touch scanning time through twice scanning operations and does not affect the touch result of a touch display device.

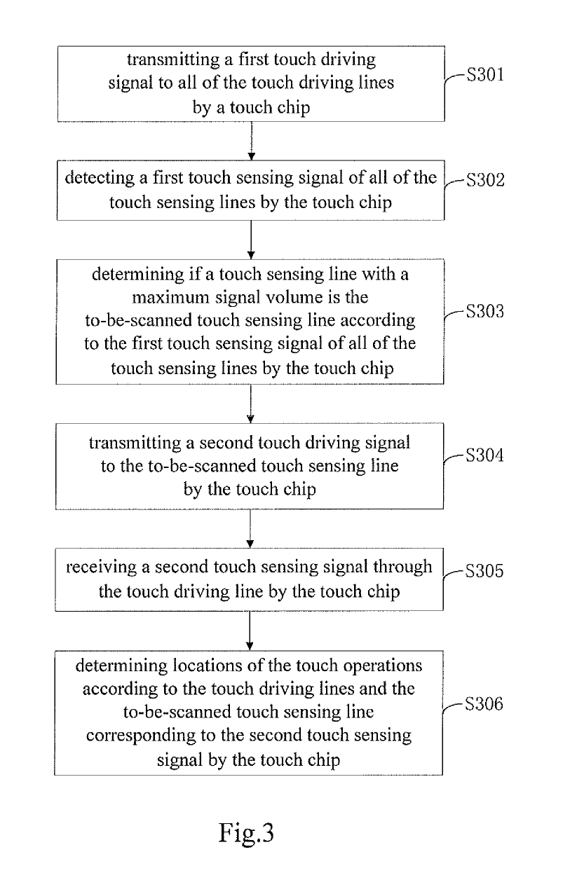

Refer to FIG. 3, which is a flowchart of the touch signal scanning method according to the second preferred embodiment of the present invention. The touch signal scanning method is used in a single point touch display device, comprising:

In a step S301, the touch chip transmits a first touch driving signal to all of the touch driving lines;

In a step S302, the touch chip detects a first touch sensing signal of all of the touch sensing lines;

In a step S303, the touch chip determines if a touch sensing line with a maximum signal volume is the to-be-scanned touch sensing line according to the first touch sensing signal of all of the touch sensing lines;

In a step S304, the touch chip transmits a second touch driving signal to the to-be-scanned touch sensing line;

In a step S305, the touch chip receives a second touch sensing signal through the touch driving line; and

In a step S306, the touch chip determining locations of the touch operations according to the touch driving lines and the to-be-scanned touch sensing line corresponding to the second touch sensing signal.

The touch signal scanning method of the present preferred embodiment is described in detailed below.

The step S301 and the step S302 of the touch signal scanning method of the present preferred embodiment are the same as the step S201 and the step S202 of the first preferred embodiment.

At the step S303, the touch chip sets the touch sensing line which has maximum signal volume as the to-be-scanned touch sensing line according to the first sensing line of the touch sensing line. There is only one touch operation point of the signal point touch display device, so that the signal volume of the sensing signal of the touch sensing line which has a touch operation is the largest. Then, go to the step S304.

The step S304 and the step S305 of the touch signal scanning method of the present preferred embodiment are the same as the step S204 and the step S205 of the first preferred embodiment.

At the step S306, the touch chip obtains the touch driving line corresponding to the second touch sensing signal at the step S305 and obtains the to-be-scanned touch sensing line at the step S303. The intersection of the touch sensing line of the second touch sensing signal and the to-be-scanned touch sensing line is the single point touch operation location.

As a result, the touch signal scanning process of the touch signal scanning method of the present preferred embodiment is completed.

According to characteristics of single point touch operations of a single point touch display device, the touch signal scanning method of the present invention determines locations of the single point touch operations through twice scanning operations, so as to shorten touch scanning time and do not affect the touch result of the single point touch display device.

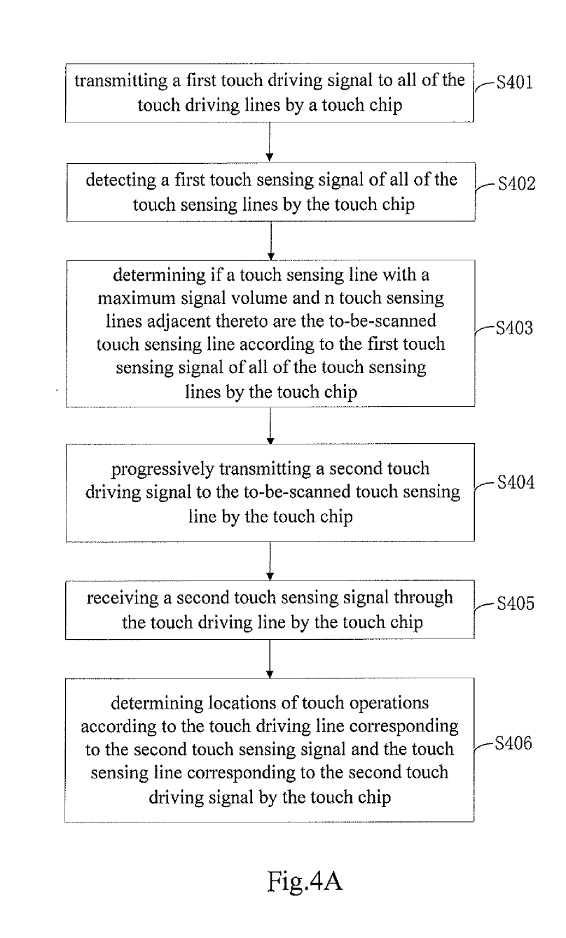

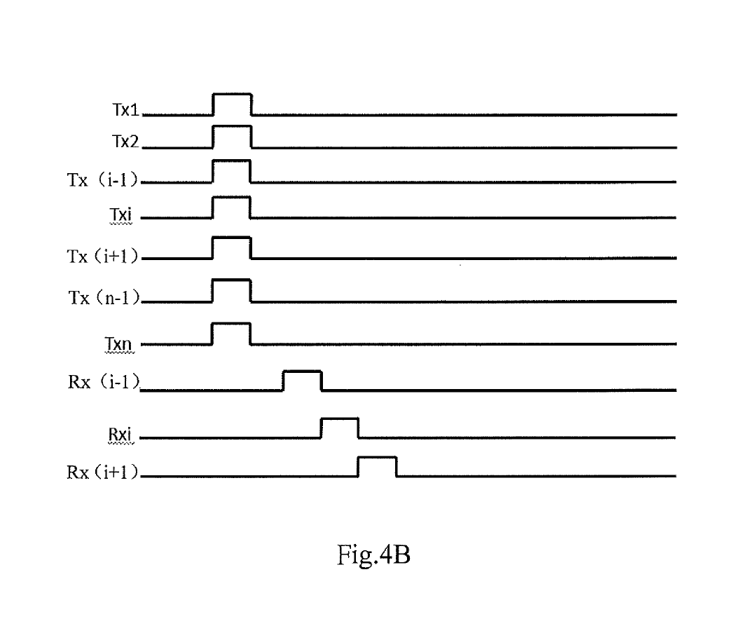

Referring to FIG. 4A and FIG. 4B, FIG. 4A is a flowchart of the touch signal scanning method according to the third preferred embodiment of the present invention, FIG. 4B is a diagram of touch signals of the touch signal scanning method according to the third preferred embodiment of the present invention. The touch signal scanning method of the present preferred embodiment is used in a single point touch display device, and comprises:

In a step S401, the touch chip transmits a first touch driving signal to all of the touch driving lines;

In a step S402, the touch chip detects a first touch sensing signal of all of the touch sensing lines;

In a step S403, the touch chip determines if a touch sensing line with a maximum signal volume and n touch sensing lines adjacent thereto are the to-be-scanned touch sensing line according to the first touch sensing signal of all of the touch sensing lines;

In a step S404, the touch chip progressively transmits a second touch driving signal to the to-be-scanned touch sensing line;

In a step S405, the touch chip receives a second touch sensing signal through the touch driving line; and

In a step S406, the touch chip determines locations of touch operations according to the touch driving line corresponding to the second touch sensing signal and the touch sensing line corresponding to the second touch driving signal.

The touch signal scanning method of the present preferred embodiment is described in detailed below.

At the step S401, the touch chip transmits a first touch driving signal to all of the touch driving lines (Tx1, Tx2 . . . Txn) at the same time, as illustrated in FIG. 4B. Then, go to the step S402.

At the step S402, the touch sensing lines (Rx1, Rx2 . . . Rxm) produce the first touch sensing signals according to the first touch driving signal of the touch driving line and touch operations on the touch display panel; and then, the touch chip detects a first touch sensing signal of all of the touch sensing lines; then, go to the step S403.

At the step S403, the touch chip sets the touch sensing line Rxi which has the maximum signal volume as the to-be-scanned touch sensing line according to the first touch sensing signal of the touch sensing line. There is only one touch operation point of the single point touch display device, so that the signal volume of the sensing signal of the touch sensing line which has a touch operation is the largest. Simultaneously, to avoid detection error, set n touch sensing lines adjacent to the touch sensing line with the maximum signal volume Rxi as the to-be-scanned touch sensing lines. Wherein n is a positive integer, and the preferred value is 1. At the present step, three to-be-scanned sensing lines are set, and that are the touch sensing line Rx(i−1), the touch sensing line Rxi, and the touch sensing line Rx(i+1). Then, go to the step S404.

At the step S404, the touch chip progressively transmits the second touch driving signal to the to-be scanned touch sensing lines (Rx(i−1), Rxi, Rx(i+1)) which are set at the step S403. The touch chip executes the second time scanning for the to-be-scanned touch sensing line. From the step S401 to the step S403, the once overall scanning and the default rule of the maximum signal volume reduce the second time scanning area, so that the time consuming of the second time scanning is lower. Then, go the step S405.

At the step S405, the touch sensing lines produces the second touch sensing signal according to the second touch driving signal and touch operations of the touch display panel; then, the touch chip detects the second touch sensing signal of the touch driving line; then, go to the step S406.

At the step S406, the touch chip obtains a touch driving line corresponding to the second touch sensing signal at the step S405, and obtains the to-be-scanned touch sensing line at the step S403. The intersection of the touch driving line corresponding to the second touch sensing signal and the to-be-scanned touch sensing line is the position of the single touch operation. At the step S404, the second touch driving signal is transmitted to the to-be-scanned touch sensing line Rxi. The touch chip detects that the touch driving line Txi has the second touch sensing signal, and the intersection of the to-be-scanned touch sensing line Rxi and the touch driving line Txi is set as the position of single point touch operation.

As a result, the touch signal scanning process of the touch signal scanning method of the present preferred embodiment is completed.

In the touch signal scanning method of the second preferred embodiment of the present invention, a plurality of to-be-scanned touch sensing line are disposed, so as to shorten the touch scanning time and improve the accuracy of the touch operation detection.

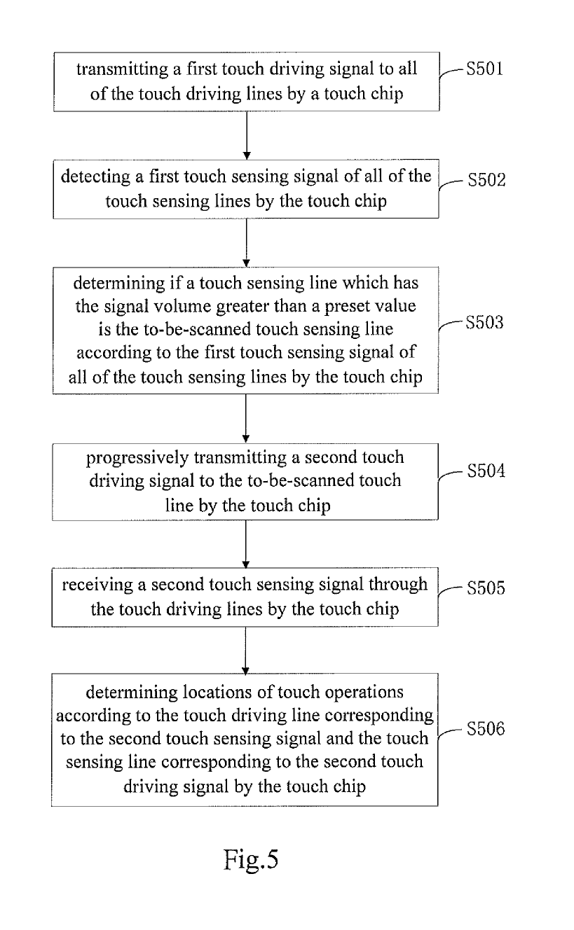

Refer to FIG. 5, which is a flowchart of the touch signal scanning method according to the fourth preferred embodiment of the present invention. The touch signal scanning method is used to a multiple point touch display device, comprising:

In a step S501, the touch chip transmits a first touch driving signal to all of the touch driving lines;

In a step S502, the touch chip detects a first touch sensing signal of all of the touch sensing lines;

In a step S503, a touch sensing line which has the signal volume greater than a preset value is determined if it is the to-be-scanned touch sensing line according to the first touch sensing signal of all of the touch sensing lines;

In a step S504, the touch chip progressively transmits a second touch driving signal to the to-be-scanned touch sensing line;

In a step S505, the touch chip receives a second touch sensing signal through the touch driving lines; and

In a step S506, the touch chip determines locations of touch operations according to the touch driving line corresponding to the second touch sensing signal and the touch sensing line corresponding to the second touch driving signal.

The step S501 and the step S502 of the touch signal scanning method of the present preferred embodiment are the same as the step S401 and the step S402 of the third preferred embodiment.

At the step S503, the touch chip determining if a touch sensing line which has the signal volume greater than a preset value is the to-be-scanned touch sensing line according to the first touch sensing signal of all of the touch sensing lines. The multiple point touch display device has at least one touch operation point, so as to determine the touch sensing line which has the signal volume greater than a preset value has a touch operation, and a plurality of to-be-scanned touch sensing lines are disposed here. Then, turn to the step S504.

At the step S504, the touch chip progressively transmits the second touch driving signal to the to-be scanned touch sensing lines which are set at the step S503. The touch chip executes the second time scanning for the to-be-scanned touch sensing line. From the step S501 to the step S503, the once overall scanning and the default rule of the signal volume setting value reduce the second time scanning area, so that the time consumption of the second time scanning is lower. Then, go the step S505.

The step S505 of the touch signal scanning method of the present preferred embodiment is the same as the step S405 of the third preferred embodiment.

At the step S506, the touch chip obtains a touch driving line corresponding to the second touch sensing signal at the step S505, and obtains the to-be-scanned touch sensing line at step S503. A plurality of to-be-connected touch sensing lines can be obtained at the step S503, so as to obtain a plurality of the corresponding touch driving lines at the step S505; the intersections of multiple touch driving lines corresponding to the second touch sensing signal and multiple to-be-scanned touch sensing lines are positions of the touch operations.

According to characteristics of multiple point touch operations of a multiple point touch display device, the touch signal scanning method of the present invention determines locations of the multiple point touch operations through twice scanning operations, so as to shorten touch scanning time and not affect the touch result of the multiple point touch display device.

A touch signal scanning method of the present invention shortens touch scanning time through twice scanning operations and does not affect the touch result of a touch display device, so as to solve a technical problem of an existing touch signal scanning method which has too short touch scanning time, so as to affect the touch result of the touch display result.

In summary, the present invention has been disclosed with preferred embodiments thereof, but the above described preferred embodiments are not intended to limit the present invention. Those who are skilled in the art can make many changes and modifications to the described embodiment which can be carried out without departing from the scope and the spirit of the invention that is intended to be limited only by the appended claims.

What is claimed is:

1. A touch signal scanning method, applied to a corresponding touch display device, wherein the touch display device comprises:
at least one touch chip transmitting touch driving signals and receiving touch sensing signals;
a plurality of touch driving lines connected to the touch chip; and
a plurality of touch sensing lines connected to the touch chip; wherein the touch chip scanning method comprises steps of:
transmitting a first touch driving signal to all of the touch driving lines by the touch chip;
detecting a first touch sensing signal of all of the touch sensing lines by the touch chip, wherein the touch sensing lines produce the first touch sensing signals according to the first touch driving signal and touch operations;
determining at least one to-be-scanned touch sensing line according to the first touch sensing signal of all of the touch sensing lines and a default rule by the touch chip;
transmitting a second touch driving signal to the to-be-scanned touch sensing line by the touch chip;
receiving a second touch sensing signal through the touch driving lines by the touch chip;
producing the second touch sensing signal according to the second touch driving signal and touch operations by the touch sensing lines; and
determining locations of the touch operations according to the second touch sensing signal by the touch chip;
wherein the touch driving lines are perpendicular to the touch sensing lines.

2. The touch signal scanning method according to claim 1, wherein the touch display device is a single point touch display device, and the step of determining the at least one to-be-scanned touch sensing line according to the first touch sensing signal of all of the touch sensing lines and the default rule comprises:
determining if a touch sensing line with a maximum signal volume is the to-be-scanned touch sensing line according to the first touch sensing signal of all of the touch sensing lines.

3. The touch signal scanning method according to claim 2, wherein the step of determining locations of the touch operations according to the second touch sensing signal by the touch chip comprises:
determining locations of the touch operations according to the touch driving lines and the to-be-scanned touch sensing line corresponding to the second touch sensing signal by the touch chip.

4. The touch signal scanning method according to claim 1, wherein the touch display device is a single point touch display device, and the step of determining at least one to-be-scanned touch sensing line according to the first touch sensing signal of all of the touch sensing lines and the default rule comprises:
determining if a touch sensing line with a maximum signal volume and n touch sensing lines adjacent thereto are the to-be-scanned touch sensing line according to the first touch sensing signal of all of the touch sensing lines, wherein n is a positive integer.

5. The touch signal scanning method according to claim 4, wherein n is 1.

6. The touch signal scanning method according to claim 4, wherein the step of transmitting the second touch signal to the to-be-scanned touch sensing line by the touch chip comprises:
progressively transmitting the second touch driving signal to the to-be-scanned touch sensing line by the touch chip.

7. The touch signal scanning method according to claim 4, wherein the step of determining locations of the touch operations according to the second touch sensing signal by the touch chip comprises:
determining locations of touch operations according to the touch driving line corresponding to the second touch sensing signal and the touch sensing line corresponding to the second touch driving signal by the touch chip.

8. The touch signal scanning method according to claim 1, wherein the touch display device is a multiple point touch display device, and the step of determining at least one touch to-be-scanned sensing line according to the first touch sensing signal of all of the touch sensing lines and the default rule comprises:
determining if a touch sensing line which has a signal volume greater than a preset value is the to-be-scanned touch sensing line according to the first touch sensing signal of all of the touch sensing lines.

9. The touch signal scanning method according to claim 8, wherein the step of transmitting the second touch signal to the to-be-scanned touch sensing line by the touch chip comprises:
progressively transmitting the second touch driving signal to the to-be-scanned touch sensing line by the touch chip.

10. The touch signal scanning method according to claim 9, wherein the step of determining locations of the touch operations according to the second touch sensing signal by the touch chip comprises:
determining locations of touch operations according to the touch driving line corresponding to the second touch sensing signal and the touch sensing line corresponding to the second touch driving signal by the touch chip.

11. A touch signal scanning method, applied to a corresponding touch display device, wherein the touch display device comprises:
at least one touch chip transmitting touch driving signal and receiving touch sensing signal;
a plurality of touch driving lines connected to the touch chip; and
a plurality of touch sensing lines connected to the touch chip; wherein the touch chip scanning method comprises steps of:
transmitting a first touch driving signal to all of the touch driving lines by the touch chip;
detecting a first touch sensing signal of all of the touch sensing lines by the touch chip, wherein the touch sensing lines produce the first touch sensing signals according to the first touch driving signal and touch operations;
determining at least one to-be-scanned touch sensing line according to the first touch sensing signal of all of the touch sensing lines and a default rule by the touch chip;
transmitting a second touch driving signal to the to-be-scanned touch sensing line by the touch chip;
receiving a second touch sensing signal through the touch driving lines by the touch chip;
producing the second touch sensing signal according to the second touch driving signal and touch operations by the touch sensing lines; and
determining locations of the touch operations according to the second touch sensing signal by the touch chip.

12. The touch signal scanning method according to claim 11, wherein the touch display device is a single point touch display device, and the step of determining at least one to-be-scanned touch sensing line according to the first touch sensing signal of all of the touch sensing lines and the default rule comprises:
determining if a touch sensing line with a maximum signal volume is the to-be-scanned touch sensing line according to the first touch sensing signal of all of the touch sensing lines.

13. The touch signal scanning method according to claim 12, wherein the step of determining locations of the touch operations according to the second touch sensing signal by the touch chip comprises:
determining locations of the touch operations according to the touch driving lines and the to-be-scanned touch sensing line corresponding to the second touch sensing signal by the touch chip.

14. The touch signal scanning method according to claim 11, wherein the touch display device is a single point touch display device, and the step of determining at least one to-be-scanned touch sensing line according to the first touch sensing signal of all of the touch sensing lines and the default rule comprises:
determining if a touch sensing line with a maximum signal volume and n touch sensing lines adjacent thereto are the to-be-scanned touch sensing line according to the first touch sensing signal of all of the touch sensing lines, wherein n is a positive integer.

15. The touch signal scanning method according to claim 14, wherein n is 1.

16. The touch signal scanning method according to claim 14, wherein the step of transmitting the second touch signal to the to-be-scanned touch sensing line by the touch chip comprises:
progressively transmitting the second touch driving signal to the to-be-scanned touch sensing line by the touch chip.

17. The touch signal scanning method according to claim 14, wherein the step of determining locations of the touch operations according to the second touch sensing signal by the touch chip comprises:
determining locations of touch operations according to the touch driving line corresponding to the second touch sensing signal and the touch sensing line corresponding to the second touch driving signal by the touch chip.

18. The touch signal scanning method according to claim 11, wherein the touch display device is a multiple point touch display device, and the step of determining at least one to-be-scanned touch sensing line according to the first touch sensing signal of all of the touch sensing lines and the default rule comprises:
determining if a touch sensing line which has the signal volume greater than a preset value is the to-be-scanned touch sensing line according to the first touch sensing signal of all of the touch sensing lines.

19. The touch signal scanning method according to claim 18, wherein the step of transmitting the second touch signal to the to-be-scanned touch sensing line by the touch chip comprises:
progressively transmitting the second touch driving signal to the to-be-scanned touch sensing line by the touch chip.

20. The touch signal scanning method according to claim 19, wherein the step of determining locations of the touch operations according to the second touch sensing signal by the touch chip comprises:
determining locations of touch operations according to the touch driving line corresponding to the second touch sensing signal and the touch sensing line corresponding to the second touch driving signal by the touch chip.
